(19) United States
(12) Patent Application Publication
(10) Pub. No.: US 2017/0147921 A1
(43) Pub. Date: May 25, 2017

(54) LEARNING APPARATUS, RECORDING MEDIUM, AND LEARNING METHOD

(71) Applicant: Ryosuke KASAHARA, Kanagawa (JP)

(72) Inventor: Ryosuke KASAHARA, Kanagawa (JP)

(21) Appl. No.: 15/348,165

(22) Filed: Nov. 10, 2016

(30) Foreign Application Priority Data
Nov. 24, 2015 (JP) 2015-228433

(51) Int. Cl. G06N 3/08; G06N 3/04

(52) U.S. Cl. CPC G06N 3/08; G06N 3/04

(57) ABSTRACT

A learning apparatus includes: a learning performing unit configured to learn parameters of a multilayer neural network with regularization; a determining unit configured to determine whether learning has progressed; and a changing unit configured to reduce effect of the regularization in response to the determining unit determining that the learning has progressed.

### CROSS-REFERENCE TO RELATED APPLICATIONS

The present application claims priority under 35 U.S.C. §119 to Japanese Patent Application No. 2015-228433, filed Nov. 24, 2015. The contents of which are incorporated herein by reference in their entirety.

### BACKGROUND OF THE INVENTION

1. Field of the Invention

The present invention relates to a learning apparatus, a recording medium, and a learning method.

2. Description of the Related Art

A large number of methods for discriminating an object and the like using machine learning have been proposed. It is known that machine learning (deep learning) using a deep layered neural network among such proposals has high discrimination performance. However, a deep-layered neural network has a disadvantage that performance of learning methods has not reached a satisfactory level.

Then, Japanese Unexamined Patent Application Publication No. H08-202674 discloses a technique in which a regularization term is added to a loss function in order to perform favorable learning.

However, the above-described technique is disadvantageous in that the magnitude of the regularization term is constant regardless of progress of learning, which limits accuracy of a learning result that is finally obtained.

### SUMMARY OF THE INVENTION

A learning apparatus includes a learning performing unit, a determining unit, and a changing unit. The learning performing unit is configured to learn parameters of a multilayer neural network with regularization. The determining unit is configured to determine whether learning has progressed. The changing unit is configured to reduce effect of the regularization in response to the determining unit determining that the learning has progressed.

### BRIEF DESCRIPTION OF THE DRAWINGS

FIG. 1 is a hardware configuration diagram of an information processing apparatus according to an embodiment;

FIG. 2 is a diagram describing an overview of machine learning algorithms;

FIG. 3 is a functional block diagram of the information processing apparatus according to the embodiment;

FIG. 4 is a diagram describing a multilayer neural network;

FIG. 5 is a diagram describing an autoencoder used for learning by a learning performing unit;

FIG. 6 is a diagram describing a stacked autoencoder used by the learning performing unit;

FIG. 7 is a diagram describing an example of a neural network simplified as a learning subject; and

FIG. 8 is a flowchart of a learning process performed by a learning unit.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

The illustrative embodiments and modifications described below may include similar elements. In the following, similar elements are denoted by a common numeral, so that repeated description can be partially omitted. A portion included in one of the embodiments and modifications may be replaced with a corresponding portion in another one of the embodiments and modifications. Configurations, positions, and the like of portions included in the embodiments and modifications are similar to the other embodiments and modifications unless otherwise specifically stated.

An embodiment has an object to provide a learning apparatus, a recording medium, and a learning method that improves accuracy of learning results.

### Embodiment

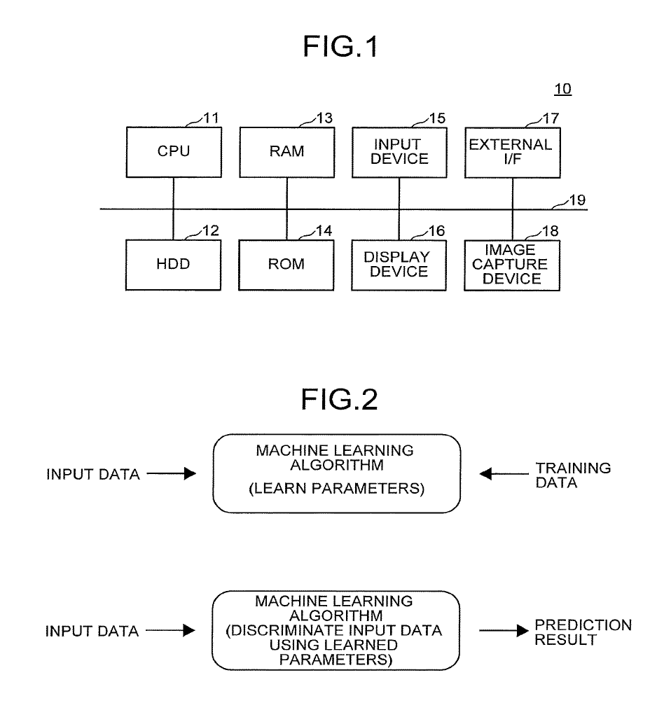

FIG. 1 is a hardware configuration diagram of an information processing apparatus 10 according to an embodiment. The information processing apparatus 10 may be, but not limited to, a personal computer, for example.

As illustrated in FIG. 1, the information processing apparatus 10, which is an example of “learning apparatus”, includes a CPU (Central Processing Unit) 11, an HDD (Hard Disk Drive) 12, a RAM (Random Access Memory) 13, a ROM (Read Only Memory) 14, an input device 15, a display device 16, an external I/F 17, an image capture device 18 that captures an image of a subject, and a bus 19. The CPU 11, the HDD 12, the RAM 13, the ROM 14, the input device 15, the display device 16, the external I/F 17, and the image capture device 18 are mutually connected via the bus 19.

The CPU 11 is a computing device that loads a program, data, and the like read out from a storage device, such as the ROM 14 and the HDD 12, into the RAM 13 and executes processing in accordance with the program, thereby controlling the entire information processing apparatus 10 and implementing functions and the like of the information processing apparatus 10.

The HDD 12 is a non-volatile storage device that stores a program, data, and the like. Examples of the program, data, and the like stored in the HDD 12 include a program for implementing the present embodiment, an OS (Operating System), which is basic software that controls the entire information processing apparatus 10, and application software providing various types of functions on the OS. The HDD 12 manages the program, data, and the like stored in the HDD 12 using a predetermined file system, a DB (database), and the like. The information processing apparatus 10 may include, in lieu of or in addition to the HDD 12, an SSD (Solid State Drive) or the like.

The RAM 13 is a volatile semiconductor memory (storage device) that temporarily stores a program, data, and the like. The ROM 14 is a non-volatile semiconductor memory (storage device) capable of holding a program, data, and the like even after power is shut down.

The input device 15 is a device used by a user to enter various types of operating signals. The input device 15 may be, for example, various types of an operating buttons, a touch panel, a keyboard, and/or a mouse.

The display device 16 is a device that displays a result of processing executed by the information processing apparatus 10. The display device 16 may be, for example, a display.

The external I/F 17 is an interface to an external device. The external device may be, for example, a USB (Universal Serial Bus) memory, an SD card, a CD, or a DVD.

FIG. 2 is a diagram describing an overview of machine learning algorithms.

As illustrated in FIG. 2, in a learning stage of a machine learning algorithm, the information processing apparatus 10 acquires input data and training data. The training data is correct answer data corresponding to the input data. The information processing apparatus 10 causes the machine learning algorithm to learn parameters used by a neural network to calculate output data from the input data, using the input data and the training data, to optimize the parameters. In a prediction phase, the machine learning algorithm discriminates the input data using the parameters optimized through learning and outputs a prediction result as output data. The information processing apparatus 10 according to the embodiment relates to, among these processes, machine learning in the parameter learning phase and, more particularly, relates to parameter optimization in a multilayer neural network.

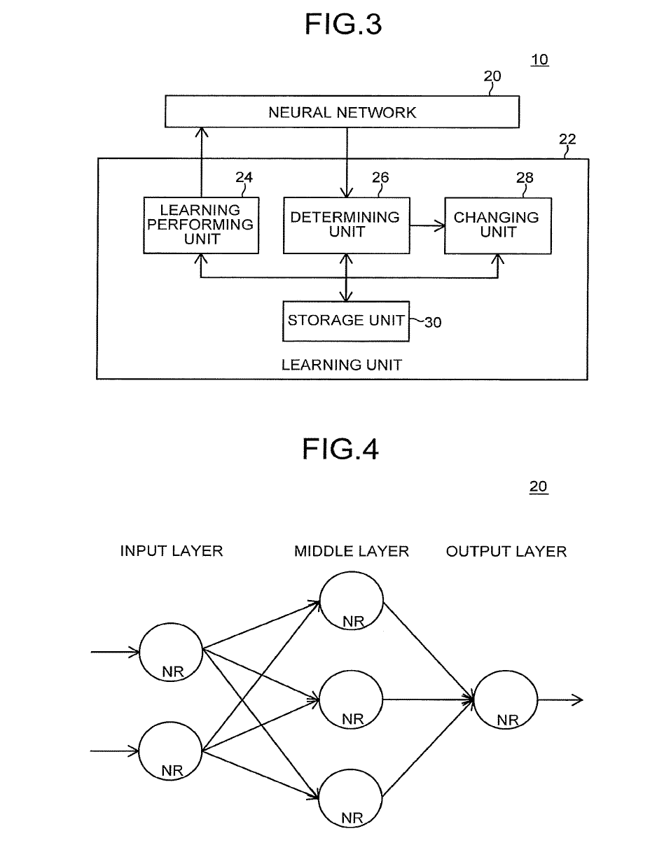

FIG. 3 is a functional block diagram of the information processing apparatus 10 according to the embodiment.

As illustrated in FIG. 3, the information processing apparatus 10 includes a neural network 20 and a learning unit 22. The neural network 20 may alternatively be installed on another information processing apparatus or the like. The learning unit 22 includes a learning performing unit 24, a determining unit 26, a changing unit 28, and a storage unit 30. In the information processing apparatus 10, the CPU 11 reads out a program stored in the HDD 12, the ROM 14, an external storage device, and/or the like, to thereby function as the neural network 20 and the learning unit 22. The program executed in the information processing apparatus 10 of the present embodiment is configured in modules including the neural network 20 and the learning unit 22 described above. From the perspective of actual hardware, the CPU 11 reads out a program from the HDD 12, the ROM 14, and/or the like, which functions as a main storage device, and executes the program, thereby loading the units onto the main storage device, so that the neural network 20 and the learning unit 22 are generated on the main storage device.

An example of the neural network 20 is a multilayer neural network. FIG. 4 is a diagram describing a multilayer neural network.

As illustrated in FIG. 4, the multilayer neural network, which is an example of the neural network 20, is a feedforward neural network where neurons NR are arranged in a plurality of layers. A multilayer neural network is sometimes referred to as a multilayer perceptron. For example, a multilayer neural network has a multilayer structure in which the neurons NR of each layer are connected to one neuron NR or a plurality of neurons NR of another layer.

The learning performing unit 24 learns parameters of the multilayer neural network with regularization.

Specifically, the learning performing unit 24 causes a stacked autoencoder to learn (i.e., optimize) parameters (e.g., weight parameters between layers) used in the multilayer neural network, by backpropagation.

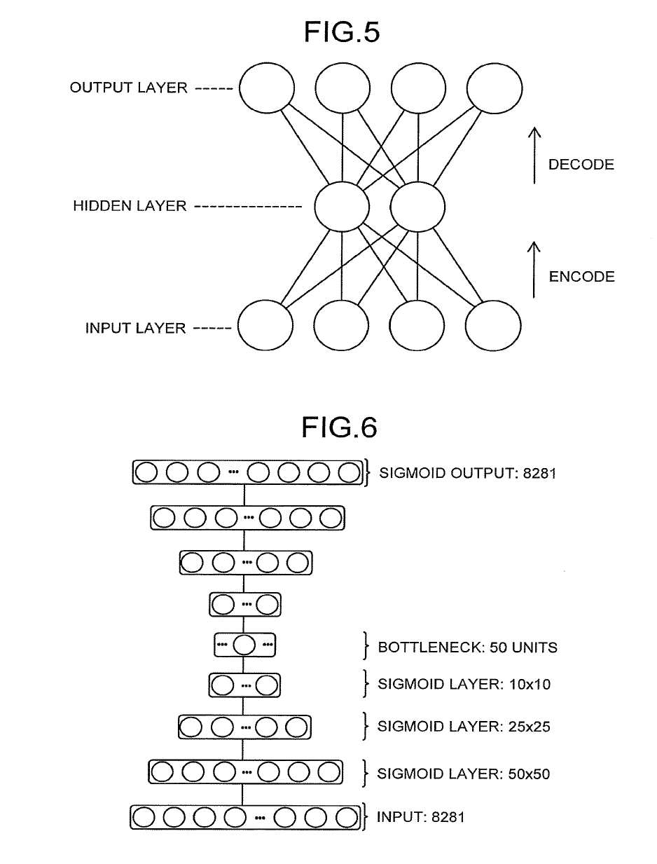

FIG. 5 is a diagram describing an autoencoder used for learning by the learning performing unit 24.

As illustrated in FIG. 5, an autoencoder is known as a method for dimensionality reduction (or dimensionality compression) using the neural network 20. An autoencoder can reduce the number of neurons in a middle layer to become smaller than the dimensionality in an input layer, thereby achieving dimensionality reduction so that the input data is reconstructed with less dimensionality.

FIG. 6 is a diagram describing a stacked autoencoder used by the learning performing unit 24 (see: http://haohanw.blogspot.jp/2014/12/ml-my-journal-from-neural-network-to_22.html#!/2014/12/ml-my-journal-from-neural-network-to_22.html).

It is known that when configured to have a multilayer structure as illustrated in FIG. 6, the neural network 20 has greater expressiveness, exhibits higher ability as a discriminator, and achieves dimensionality reduction. Therefore, ability as a dimensionality reducer when reducing dimensionality can be increased by reducing the dimensionality over two or more layers rather than reducing the dimensionality to a desired dimensionality in one layer. A method known as stacked autoencoder that uses a dimensionality reducer formed by stacking autoencoders is known. In particular, learning is performed one layer by one layer using the above-described autoencoders, the layers after learning are combined, and learning which is generally referred to as fine training, is performed to form a stacked autoencoder having multiple layers. A stacked autoencoder can achieve efficient dimensionality reduction and therefore exhibits increased ability as a dimensionality reducer.

Convolutional neural network (CNN), which is an example of the neural network 20, is described below.

Convolutional neural network is an approach commonly used in the deep layered neural network 20 for images. Learning is performed by general backpropagation, and two structurally important features are convolution and pooling described below.

A convolution operation connects only layers that are positionally close to each other on an image, rather than making all connections between layers. Convolution parameters are independent of positions on the image. Qualitatively, a convolutional neural network performs feature extraction by convolution. A convolutional neural network has an effect of limiting connections and thereby preventing over-learning.

Pooling causes positional information to be lost when one layer is connected to the next layer. Qualitatively, location invariance is obtained by pooling. Types of pooling include max pooling that takes on a maximum value and mean pooling that takes on a mean value.

Backpropagation, which is an example of a learning method used by the neural network 20, is described below.

The neural network 20 performs learning using backpropagation. In the backpropagation, output data of the neural network 20 is compared against training data, and errors of the respective output neurons NR are calculated based on the comparison. Assuming that errors of the output neurons NR are caused by the neurons NR belonging to the previous layer and connected to the output neurons NR, connection weight parameters for the neurons NR are updated so as to reduce the errors. Differences between desired output data and actual output data of the neuron NR belonging to the previous layer are calculated. These difference are referred to as local errors. Assuming that the local errors are caused by the neuron NR belonging to the layer previous to the previous layer, connection weight parameters for the neuron NR belonging to the layer previous to the previous layer are updated. In this manner, weight parameters are updated to sequentially go back to the neurons NR in the more previous layer, and weight parameters of all connections between the neurons NR are finally updated. This is an overview of backpropagation.

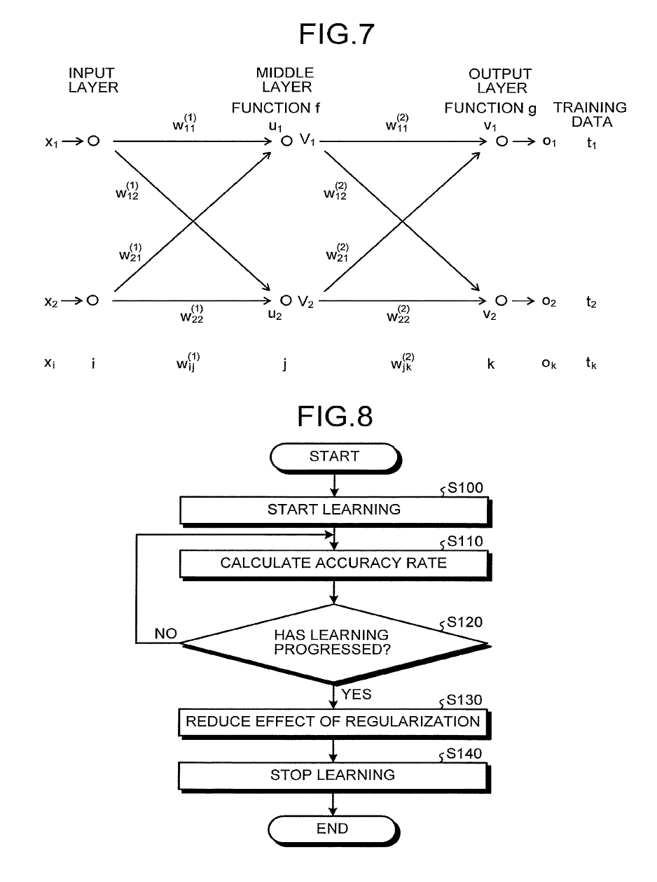

FIG. 7 is a diagram describing an example of a neural network simplified as a learning subject. How the learning performing unit 24 performs learning of the neural network illustrated in FIG. 7 including an input layer, a middle layer, and an output layer is described below.

The number of units included in each layer is two. Definitions of the symbols are as follows:

xᵢ: input data fed to input layer units i;

wᵢⱼ⁽¹⁾: weight parameters from the input layer units i to middle layer units j;

wⱼₖ⁽²⁾: weight parameters from the middle layer units j to output layer units k;

uⱼ: input to the middle layer units j;

vₖ: input to the output layer units k;

Vⱼ: output from the middle layer units j;

f(uⱼ): an output function from the middle layer units j;

g(vₖ): an output function from the output layer units k;
oₖ: output data from the output layer units k; and

tₖ: training data from the output layer units k.

A squared error between output data and training data is used as a cost function E. In this case, the learning performing unit 24 calculates the cost function E using Equation (1) given below.

$$E = \frac{1}{2} {\sum }_{k = 1}^{2} {( {t}_{k} - {o}_{k} )}^{2} \qquad ( 1 )$$

The output data oₖ satisfies Equation (2) and Equation (3) given below.

$$\begin{matrix}{o}_{k} = g ( {v}_{k} ) & ( 2 ) \\ {o}_{k} = g ( {\sum }_{a = 1}^{2} {w}_{ak}^{( 2 )} {V}_{a} ) & ( 3 )\end{matrix}$$

How the learning performing unit 24 calculates the optimum weight parameters wᵢⱼ⁽¹⁾ and wⱼₖ⁽²⁾ by stochastic gradient descent (SGD) to perform learning is described below. Update equations for the weight parameters wᵢⱼ⁽¹⁾ and the weight parameters wᵢₖ⁽²⁾ are Equation (4) and Equation (5) given below. The weight parameters wⱼₖ⁽²⁾′ and the weight parameters wᵢⱼ⁽¹⁾′ are weight parameters each obtained by an update. In Equation (4) and Equation (5), a denotes learning rate.

$$\begin{matrix}{w}_{jk}^{{( 2 )}^{′}} = {w}_{jk}^{( 2 )} - α \frac{\partial E}{\partial {w}_{jk}^{( 2 )}} & ( 4 ) \\ {w}_{ij}^{{( 1 )}^{′}} = {w}_{ij}^{( 1 )} - α \frac{\partial E}{\partial {w}_{ij}^{( 1 )}} & ( 5 )\end{matrix}$$

The weight parameters wⱼₖ⁽²⁾ between the middle layer and the output layer satisfy Equation (6) given below.

$$\begin{matrix}\frac{\partial E}{\partial {w}_{jk}^{( 2 )}} = \frac{\partial E}{\partial {o}_{k}} \frac{\partial {o}_{k}}{\partial {w}_{jk}^{( 2 )}} \\ = \frac{\partial }{\partial {o}_{k}} ( \frac{1}{2} {\sum }_{a = 1}^{2} {( {t}_{a} - {o}_{a} )}^{2} ) \frac{\partial }{\partial {w}_{jk}^{( 2 )}} g ( {\sum }_{a = 1}^{2} {w}_{ak}^{( 2 )} {V}_{a} ) \\ = - ( {t}_{k} - {o}_{k} ) {V}_{j} \frac{\partial g ( {v}_{k} )}{\partial {v}_{k}}\end{matrix} \qquad ( 6 )$$

When Equation (7) given below is satisfied, substituting Equation (7) to Equation (6) yields Equation (8).

$$\begin{matrix}{ɛ}_{k} = \frac{\partial E}{\partial {o}_{k}} = - ( {t}_{k} - {o}_{k} ) & ( 7 ) \\ \frac{\partial E}{\partial {w}_{jk}^{( 2 )}} = {ɛ}_{k} {V}_{j} \frac{\partial g ( {v}_{k} )}{\partial {v}_{k}} & ( 8 )\end{matrix}$$

Error signals of the output layer units k are denoted by εₖ.

The weight parameters wij⁽¹⁾ between the input layer and the middle layer satisfy Equation (9) given below.

$$\begin{matrix}\frac{\partial E}{\partial {w}_{tj}^{( 1 )}} = \frac{\partial E}{\partial {V}_{j}} \frac{\partial {V}_{j}}{\partial {w}_{ij}^{( 1 )}} \\ = {\sum }_{k = 1}^{2} ( \frac{\partial E}{\partial {o}_{k}} \frac{\partial {o}_{k}}{\partial {V}_{j}} ) \cdot \frac{\partial {V}_{j}}{\partial {w}_{ij}^{( 1 )}} \\ = {\sum }_{k = 1}^{2} ( {ɛ}_{k} \frac{\partial }{\partial {V}_{j}} g ( {\sum }_{a = 1}^{2} {w}_{ak}^{( 2 )} {V}_{a} ) ) \cdot \frac{\partial {V}_{j}}{\partial {w}_{ij}^{( 1 )}} \\ = {\sum }_{k = 1}^{2} ( {ɛ}_{k} {w}_{jk}^{( 2 )} \frac{\partial g ( {v}_{k} )}{\partial {v}_{k}} ) \cdot \frac{\partial {V}_{j}}{\partial {w}_{ij}^{( 1 )}} \\ = {\sum }_{k = 1}^{2} ( {ɛ}_{k} {w}_{jk}^{( 2 )} \frac{\partial g ( {v}_{k} )}{\partial {v}_{k}} ) \cdot \frac{\partial }{\partial {w}_{ij}^{( 1 )}} ( f ( {\sum }_{a = 1}^{2} {w}_{aj}^{( 1 )} {x}_{a} ) ) \\ = {\sum }_{k = 1}^{2} ( {ɛ}_{k} {w}_{jk}^{( 2 )} \frac{\partial g ( {v}_{k} )}{\partial {v}_{k}} ) \cdot {x}_{i} \frac{\partial f ( {u}_{i} )}{\partial {u}_{i}}\end{matrix} \qquad ( 9 )$$

Here, error signals εⱼ of the middle layer units j are defined by Equation (10) given below.

$${ɛ}_{j} = {\sum }_{k = 1}^{2} ( {ɛ}_{k} {w}_{jk}^{( 2 )} \frac{\partial g ( {v}_{k} )}{\partial {v}_{k}} ) \cdot \frac{\partial f ( {u}_{i} )}{\partial {u}_{i}} \qquad ( 10 )$$

Substituting Equation (10) to Equation (9) yields Equation (11).

$$\frac{\partial E}{\partial {w}_{ij}^{( 1 )}} = {ɛ}_{j} {x}_{i} \qquad ( 11 )$$

When the number of middle layer units is K, the error signals εⱼ are defined by Equation (12), which is obtained by generalizing Equation (10).

$${ɛ}_{j} = {\sum }_{k = 1}^{K} ( {ɛ}_{k} {w}_{jk}^{( 2 )} \frac{\partial g ( {v}_{k} )}{\partial {v}_{k}} ) \cdot \frac{\partial f ( {u}_{i} )}{\partial {u}_{i}} \qquad ( 12 )$$

When the number of the middle layer units is K, update equations for the weight parameters wⱼₖ⁽²⁾ and the weight parameters wᵢⱼ⁽¹⁾ are Equation (13) and Equation (14) given below. The learning performing unit 24 calculates the weight parameters wⱼₖ⁽²⁾ and the weight parameters wᵢⱼ⁽¹⁾ using update equations obtained by substituting Equation (7) and Equation (12) to Equation (13) and Equation (14), respectively. Furthermore, when the number of the middle layers is increased, the learning performing unit 24 calculates the weight parameters wⱼₖ⁽²⁾ and the weight parameters wᵢⱼ⁽¹⁾ using update equations where error signals in a previous layer are used in a similar manner.

$$\begin{matrix}{w}_{jk}^{{( 2 )}^{′}} = {w}_{jk}^{( 2 )} - {αɛ}_{k} {V}_{j} \frac{\partial g ( {v}_{k} )}{\partial {v}_{k}} & ( 13 ) \\ {w}_{ij}^{{( 1 )}^{′}} = {w}_{ij}^{( 1 )} - {αɛ}_{j} {x}_{i} & ( 14 )\end{matrix}$$

How the learning performing unit 24 calculates the weight parameters wⱼₖ⁽²⁾ and the weight parameters wᵢⱼ⁽¹⁾ when two input data, which are learning data, are given has been described above. Hereinafter, how the learning performing unit 24 calculates the weight parameters wⱼₖ⁽²⁾ and the weight parameters wᵢⱼ⁽¹⁾ when a plurality of (e.g., three or more) input data are given. The number of the input data is referred to as N; the n^{th} input data is referred to as xᵢⁿ; error signals of the respective units related to the n^{th} data are referred to as εₖⁿ and εⱼⁿ. When the learning performing unit 24 performs optimization by gradient descent, the learning performing unit 24 calculates the weight parameters wⱼₖ⁽²⁾ and the weight parameters wᵢⱼ⁽¹⁾ by updates using update equations, which are Equation (15) and Equation (16) given below.

$$\begin{matrix}{w}_{jk}^{{( 2 )}^{′}} = {w}_{jk}^{( 2 )} - α {\sum }_{n}^{N} {ɛ}_{k}^{n} {V}_{j}^{n} \frac{\partial g ( {v}_{k}^{n} )}{\partial {v}_{k}^{n}} & ( 15 ) \\ {w}_{ij}^{{( 1 )}^{′}} = {w}_{ij}^{( 1 )} - α {\sum }_{n}^{N} {ɛ}_{j}^{n} {x}_{i}^{n} & ( 16 )\end{matrix}$$

In Equation (15) and Equation (16), a is the learning rate. When the value of the learning rate a is large, the update equations diverge. Accordingly, the learning rate a is desirably set to an appropriate value in advance depending on the input data and a structure of the neural network. Note that when the learning rate a is set to a small value to prevent divergence of the update equations, learning becomes time-consuming. For this reason, it is desirable to set the learning rate a to a maximum value within a range where divergence will not occur.

The learning performing unit 24 calculates update amounts Δwᵢⱼ⁽¹⁾′(t) in a unit step t during learning, using Equation (17) given below.

$$Δ {w}_{ij}^{{( 1 )}^{′}} ( t ) = - α {\sum }_{n}^{N} {ɛ}_{j}^{n} {x}_{i}^{n} \qquad ( 17 )$$

It is empirically known that learning can be accelerated by adding a momentum term so as to take into consideration a direction in which the parameter has changed for convergence of the weight parameters wⱼₖ⁽²⁾ and the weight parameters wᵢⱼ⁽¹⁾. Accordingly, it is preferable that the learning performing unit 24 calculates the update amounts Δwᵢⱼ⁽¹⁾′(t) using Equation (18) below, which is an update equation obtained by adding a momentum term to Equation (17).

$$Δ {w}_{ij}^{{( 1 )}^{′}} ( t ) = {ɛ}_{M} Δ {w}_{ij}^{{( 1 )}^{′}} ( t - 1 ) - α {\sum }_{n}^{N} {ɛ}_{j}^{n} {x}_{i}^{n} \qquad ( 18 )$$

In Equation (18), Δwᵢⱼ⁽¹⁾′ (t−1) are update amounts in an immediately preceding step; ε_{M} is a momentum coefficient. The momentum coefficient ε_{M} is preferably set to about 0.9 in advance.

A regularization term is described below.

The learning performing unit 24 of the present embodiment calculates the weight parameters wⱼₖ⁽²⁾ and the weight parameters wᵢⱼ⁽¹⁾ using an L2-norm-regularized cost function Ereg obtained by adding the norm of the weight parameters wⱼₖ⁽²⁾ and the weight parameters wᵢⱼ⁽¹⁾ to the cost function E. The learning performing unit 24 thus reduces convergence of the weight parameters wⱼₖ⁽²⁾ and the weight parameters wᵢⱼ⁽¹⁾ caused by over-learning.

Specifically, the learning performing unit 24 uses, as a cost function, Ereg, expressed as Equation (19) below according to L2 norm regulation, obtained by adding the L2 norm of the weight parameters wⱼₖ⁽²⁾ and the weight parameters wᵢⱼ⁽¹⁾ to the above-described cost function E. In Equation (19), λ is a parameter (hereinafter, “regularization parameter”) that controls the strength of regularization such that the larger the regularization parameter λ, the greater the effect of the regularization. L2-norm regularization is sometimes referred to as “weight decay”.

Ereg=λ\sqrt{Σ|w|²} (19)

The determining unit 26 determines progress of learning of the weight parameters wⱼₖ⁽²⁾ and the weight parameters wᵢⱼ⁽¹⁾ performed by the learning performing unit 24. For example, the determining unit 26 may compare an accuracy rate of output data obtained using the weight parameters wⱼₖ⁽²⁾ and the weight parameters wᵢⱼ⁽¹⁾ updated by the learning performing unit 24, against a determination threshold that is determined in advance and stored in the storage unit 30, to determine progress of learning. The determining unit 26 determines that learning has progressed when the accuracy rate is equal to or higher than the determination threshold. The determining unit 26 outputs a result of the determination to the changing unit 28.

The changing unit 28 reduces the effect of regularization in accordance with the progress of learning of the weight parameters wⱼₖ⁽²⁾ and the weight parameters wᵢⱼ⁽¹⁾ performed by the learning performing unit 24. For example, when learning by the learning performing unit 24 has progressed, the changing unit 28 may acquire a result of determination indicating that learning has progressed from the determining unit 26 and reduce the effect of regularization. The changing unit 28 may reduce the effect of regularization by, for example, reducing the regularization parameter λ for L2-norm regularization.

The storage unit 30 stores a program and data necessary for prediction and learning by the neural network 20. For example, the storage unit 30 may store an initial value of the regularization parameter λ, the determination threshold for determining progress of learning, and the like. The storage unit 30 may be implemented by any one of the HDD 12, the RAM 13, and the ROM 14, for example. The program and data necessary for prediction and learning by the neural network 20 may be provided as an installable file or an executable file recorded in a non-transitory, computer-readable recording medium, such as a CD-ROM, a flexible disk (FD), a CD-R, and a DVD (Digital Versatile Disk). The program and data necessary for prediction and learning by the neural network 20 may be configured to be stored in a computer connected to a network, such as the Internet, and downloaded via the network to provide the program and data. The program and data necessary for prediction and learning by the neural network 20 may be configured to be provided or delivered via a network, such as the Internet.

FIG. 8 is a flowchart of a learning process performed by the learning unit 22.

In the learning process, the learning performing unit 24 starts learning of the neural network 20 using input data and training data first (S100).

The determining unit 26 calculates an accuracy rate achieved by the neural network 20 using the weight parameters wⱼₖ⁽²⁾ and the weight parameters wᵢⱼ⁽¹⁾ updated through learning performed by the learning performing unit (S110). The determining unit 26 may perform the step S110 every predetermined number of times the weight parameters wⱼₖ⁽²⁾ and the weight parameters wᵢⱼ⁽¹⁾ are updated by the learning performing unit 24.

The determining unit 26 compares the accuracy rate against the determination threshold to determine whether or not learning has progressed (S120). If the accuracy rate is lower than the determination threshold, the determining unit 26 determines that learning has not progressed (No at S120), and iterates S110 and the following steps. On the other hand, if the accuracy rate is equal to or higher than the determination threshold, the determining unit 26 determines that learning has progressed (Yes at S120), and outputs a notice indicating that learning has progressed to the changing unit 28.

Upon receiving the notice indicating that learning has progressed, the changing unit 28 reduces the value of the regularization parameter λ to reduce the effect of regularization (S130).

Thereafter, the learning performing unit 24 continues learning using the regularization parameter λ reduced to reduce the effect of regularization. When learning has progressed to a predetermined setting, the learning performing unit 24 stops learning (S140). The learning performing unit 24 thus completes the learning process.

Advantages of the present embodiment are described below.

If conventional optimization is performed without using regularization, divergence of the weight parameters wⱼₖ⁽²⁾ and the weight parameters wᵢⱼ⁽¹⁾, convergence of the weight parameters wⱼₖ⁽²⁾ and the weight parameters wᵢⱼ⁽¹⁾ to a local solution that yields inaccurate results eventually, or the like will occur. For this reason, regularization is desirably incorporated in optimization of the weight parameters wⱼₖ⁽²⁾ and the weight parameters wᵢⱼ⁽¹⁾. However, in conventional optimization using a regularization method, learning is performed without changing the regularization parameter λ, so as to maintain the effect of regularization constant throughout the learning. Such a conventional technique is disadvantageous in that after learning has progressed to a stage where the weight parameters wⱼₖ⁽²⁾ and the weight parameters wᵢⱼ⁽¹⁾ are close to the final solutions, regularization adversely affects fine correction of the weight parameters wⱼₖ⁽²⁾ and the weight parameters wᵢⱼ⁽¹⁾, and optimum weight parameters w cannot be obtained.

By contrast, as described above, in the learning unit 22 of the information processing apparatus 10 according to the embodiment, when the determining unit 26 determines that learning by the learning performing unit 24 has progressed, the changing unit 28 reduces the regularization parameter λ for L2-norm regularization (i.e., weight decay), thereby reducing the effect of regularization. Accordingly, at a final stage where the weight parameters wⱼₖ⁽²⁾ and the weight parameters wᵢⱼ⁽¹⁾ are close to the final solutions, the learning unit 22 allows learning the weight parameters wⱼₖ⁽²⁾ and the weight parameters wᵢⱼ⁽¹⁾ that are more accurate while reducing hindrance by regularization to optimization of the weight parameters wⱼₖ⁽²⁾ and the weight parameter wᵢⱼ⁽¹⁾.

Conventional convolutional neural networks perform learning on input data, which is in many cases a considerably large amount of image data, which makes learning considerably time-consuming. However, the learning unit 22 of the present embodiment reduces the effect of regularization according to progress of learning, and thus can complete learning in a shorter period of time compared with learning by a conventional convolutional neural network. Furthermore, the learning unit 22 does not cause a problem in time even if performing learning using the neural network 20 having a deeper layer structure compared with a conventional convolutional neural network, and thus can increase accuracy of learning in the same learning time.

Learning of a conventional stacked autoencoder is generally considerably time-consuming, because layer-by-layer learning is required and, furthermore, the deep layered neural network 20 is usually input to perform fine training. By contrast, the learning unit 22 of the present embodiment can complete learning within a shorter period of time than a conventional convolutional neural network because the learning unit 22 reduces the effect of regularization on the basis of progress of learning. Furthermore, the learning unit 22 of the present embodiment does not cause a problem in time even if performing learning using the neural network 20 having a deeper layer structure compared with a conventional stacked autoencoder, and thus can increase accuracy of learning in the same learning time.

A simulation performed to demonstrate the above-described advantages of the embodiment is described below. The simulation was performed using a neural network configuration of the model described in the following monograph.

K Simonyan, A Zisserman, “Very deep convolutional networks for large-scale image recognition,” arXiv preprint, arXiv:1409.1556, 2014, arxiv.org (2015)

In this simulation, learning for a task of classifying input data which is image data of approximately 1.2 million images, into 1,000 classes was performed using a convolutional neural network of 16 layers.

When the regularization parameter λ for weight decay is set to 0.005 (λ=0.005) and the learning unit 22 performed learning, a final accuracy rate of 69.6781% was obtained. Thereafter, upon determining that learning had progressed on the basis of the accuracy rate, the regularization parameter λ, for weight decay was set to 0 (λ=0) to reduce the effect of regularization, and the learning unit 22 continued learning beginning with the weight parameters wⱼₖ⁽²⁾ and the weight parameters wᵢⱼ⁽¹⁾ that had yielded the above described accuracy rate. The continued learning by the learning unit 22 yielded an accuracy rate of 71.4125%. This simulation result indicates that the learning unit 22 of the present embodiment can achieve a high accuracy rate by, after learning has progressed, continuing learning with the effect of regularization reduced to zero. Note that if the parameter λ for weight decay is set to 0 (λ=0) from the beginning of learning, learning does not progress appropriately, causing the weight parameters wⱼₖ⁽²⁾ and the weight parameters wᵢⱼ⁽¹⁾ to diverge. Thus, the learning unit 22 of the present embodiment that controls scheduling of regularization can cause learning to progress appropriately while reducing divergence of the weight parameters wⱼₖ⁽²⁾ and the weight parameters wᵢⱼ⁽¹⁾ on the basis of progress of learning.

Modifications obtained by partially modifying the above-described embodiment are described below.

First Modification

The learning unit 22 may use L1-norm regularization as a regularization method. L1-norm regularization is a method that uses, as a cost function, Ereg, expressed as Equation (20) below, obtained by adding the L1 norm of the weight parameters w to the cost function E. In Equation (20), λ is the parameter (hereinafter, “regularization parameter”) that controls the strength of regularization such that as the regularization parameter λ increases, the effect of the regularization increases. Accordingly, the changing unit 28 of the learning unit 22 reduces the effect of regularization when learning of the weight parameters wⱼₖ⁽²⁾ and the weight parameters wᵢⱼ⁽¹⁾ by the learning performing unit 24 has progressed.

Ereg=E+λΣ|w| (20)

Second Modification

The learning unit 22 may use SGD (stochastic gradient descent).

In general gradient descent, all samples of input data are evaluated, the weight parameters wⱼₖ⁽²⁾ and the weight parameters wᵢⱼ⁽¹⁾ are updated using a sum of cost functions of all the data points as a final cost function, and optimization is performed. Therefore, a single update of the weight parameters wⱼₖ⁽²⁾ and the weight parameters wᵢⱼ⁽¹⁾ using general gradient descent is considerably time-consuming.

By contrast, SGD is a simplified variant of the above-described general gradient descent and regarded as a method appropriate for on-line learning. SGD randomly picks up one data point, and updates the weight parameters wⱼₖ⁽²⁾ and the weight parameters wᵢⱼ⁽¹⁾ with a gradient corresponding to a cost function of the picked-up data point. After updating the weight parameters wⱼₖ⁽²⁾ and the weight parameters wᵢⱼ⁽¹⁾, SGD iterates picking up another data point and updating the weight parameters wⱼₖ⁽²⁾ and the weight parameters wᵢⱼ⁽¹⁾. Thus, using SGD, the learning unit 22 can reduce time taken to update the weight parameters wⱼₖ⁽²⁾ and the weight parameters wᵢⱼ⁽¹⁾, which would otherwise take a considerably long period of time if general gradient descent was used.

Alternatively, the learning unit 22 may use a mini-batch method, which is a method intermediate between SGD and general gradient descent. The mini-batch method is frequently used in learning of a multilayer neural network. The mini-batch method separates all data into a plurality of data groups, each of which is referred to as a mini-batch, and optimizes the weight parameters wⱼₖ⁽²⁾ and the weight parameters wᵢⱼ⁽¹⁾ on a per-mini-batch basis. The learning unit 22 can reduce time taken to update the weight parameters wⱼₖ⁽²⁾ and the weight parameters wᵢⱼ⁽¹⁾ using the mini-batch method as well.

Third Modification

The learning unit 22 may use dropout as a learning method.

Dropout is a method of performing learning while randomly dropping out a middle unit(s) in the neural network 20 for each of training inputs. Dropout is a method that has a regularization effect and can increase generalization ability. In the third modification, when learning has progressed, the changing unit 28 reduces a drop rate, which is the rate of dropping out middle units in dropout, thereby reducing the effect of regularization. The learning unit 22 thus enables learning the weight parameters wⱼₖ⁽²⁾ and the weight parameters wᵢⱼ⁽¹⁾ that are highly accurate while reducing learning time.

Fourth Modification

The learning unit 22 may use dropconnect as a learning method.

By contrast to dropout that randomly drops out middle units, dropconnect randomly drops out connection between units. In the present modification, the drop rate of dropconnect is reduced as learning progresses. In the fourth modification, when learning has progressed, the changing unit 28 reduces the drop rate, which is the rate of dropping out connections between units in dropconnect, thereby reducing the effect of regularization. The learning unit 22 thus enables learning the weight parameters wⱼₖ⁽²⁾ and the weight parameters wᵢⱼ⁽¹⁾ that are highly accurate while reducing learning time.

Fifth Modification

The determining unit 26 may use the cost function E (or the cost function Ereg) as a factor, on the basis of which whether learning has progressed is to be determined. For example, the determining unit 26 may determine that learning has progressed when a rate of change of the cost function E has decreased to be lower than a predetermined rate-of-change threshold. A situation where the value of the cost function E becomes constant is included in situations where the rate of change of the cost function E has decreased to be lower than the predetermined rate-of-change threshold. In the fifth modification, when the rate of change of the cost function E has decreased to be lower than the predetermined rate-of-change threshold, the changing unit 28 reduces the effect of regularization.

Sixth Modification

The learning unit 22 may use a recurrent neural network (RNN) as the neural network 20, which is the learning subject.

Recurrent neural network is a structure of neural networks where output of a hidden layer is used as input at the next time step.

In a recurrent neural network, because outputs are fed back as inputs, the weight parameters w are prone to divergence when the learning rate is set high. For this reason, a recurrent neural network requires that the learning rate be set low so that learning is performed over a rather long period of time. However, the learning unit 22 can complete learning in a short period of time because the learning unit 22 reduces the effect of regularization when learning has progressed. Furthermore, the learning unit 22 does not cause a problem in time even if performing learning using the neural network 20 having a deeper layer structure compared with a conventional recurrent neural network, and thus can increase accuracy of learning in the same learning time.

Seventh Modification

The learning unit 22 may reduce not only the effect of regularization but also the learning rate a when learning has progressed.

According to an embodiment, accuracy of learning results can be improved.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A learning apparatus comprising:
a learning performing unit configured to learn parameters of a multilayer neural network with regularization;
a determining unit configured to determine whether learning has progressed; and
a changing unit configured to reduce effect of the regularization in response to the determining unit determining that the learning has progressed.

2. The learning apparatus according to claim 1, wherein the changing unit is configured to reduce a learning rate of the learning while reducing the effect of the regularization in response to the determining unit determining that the learning has progressed.

3. The learning apparatus according to claim 1, wherein the changing unit is configured to reduce a regularization parameter to reduce the effect of the regularization, the regularization parameter being a coefficient of a regularization term used in the regularization.

4. The learning apparatus according to claim 1, wherein the changing unit is configured to reduce a rate of dropout to reduce the effect of the regularization.

5. The learning apparatus according to claim 1, wherein the changing unit is configured to reduce a rate of dropconnect to reduce the effect of the regularization.

6. The learning apparatus according to claim 1, wherein the multilayer neural network is a convolutional neural network.

7. The learning apparatus according to claim 1, wherein the multilayer neural network is a stacked autoencoder.

8. The learning apparatus according to claim 1, wherein the multilayer neural network is a recurrent neural network.

9. The learning apparatus according to claim 1, wherein the learning performing unit is configured to learn the parameters by stochastic gradient descent.

10. A non-transitory computer-readable recording medium including a program causing a computer to execute:
learning parameters of a multilayer neural network with regularization;
determining whether learning has progressed; and
reducing effect of the regularization in response to determining that the learning has progressed.

11. A learning method performed by a learning apparatus, the learning method comprising:
learning parameters of a multilayer neural network with regularization;
determining whether learning has progressed; and
reducing effect of the regularization in response to determining that the learning has progressed.
